(19) United States
(12) Patent Application Publication
(10) Pub. No.: US 2026/0183848 A1
(43) Pub. Date: Jul. 2, 2026

(54) Masonry drill having five blades

(71) Applicant: Hilti Aktiengesellschaft, Schaan (LI)

(72) Inventor: Markus MEIERHOFER, Grabs (CH)

(21) Appl. No.: 19/131,073

(22) PCT Filed: Nov. 8, 2023
(86) PCT No.: PCT/EP2023/081107

§ 371 Date: May 19, 2025

(30) Foreign Application Priority Data
Nov. 22, 2022 (EP) 22208883.3

(51) Int. Cl. B23B 51/00

(52) U.S. Cl. CPC B23B 51/0002; B23B 51/02; B23B 2226/75; B23B 2251/205

(57) ABSTRACT

A masonry drill (10), including a shaft section (12), on which a shank section (16) for connection to a tool fitting of a power drill is formed at one end, and a drill head (18) for work on a substrate is formed at the other end. The drill head (18) has at least one blade (20) having at its outer end a projection (22) which points away from the blade (20) tangentially to the longitudinal axis (L). The masonry drill (10) has a high removal capacity and a low risk of jamming.

The invention relates to a masonry drill.

### BACKGROUND

Masonry drills of this kind are usually used for work on masonry such as reinforced concrete, for example to drill holes in the masonry.

### SUMMARY OF THE INVENTION

During this process, the masonry drill may become stuck in the masonry. This occurs particularly often if the masonry drill comes into contact with a reinforcement of reinforced masonry.

Damage to a power tool in which the masonry drill is mounted and/or injury to a user of the power tool or the masonry drill may be the result.

It an object of the present invention to offer a masonry drill which allows particularly safe work on masonry. It is also desirable if the masonry drill allows high drilling rates.

The present invention provides a masonry drill, comprising a shaft section, on which a shank section for connection to a tool fitting of a power drill is formed at one end, and a drill head for work on a substrate is formed at the other end, wherein the drill head has at least one blade running outward from a central longitudinal axis of the drill head, wherein the blade has at its outer end a projection pointing away from said blade tangentially to the longitudinal axis.

This is based on the consideration that a masonry drill gets stuck in reinforced masonry especially if a reinforcement can become jammed between blades of the drill head. It is therefore advantageous to fill as large a volume as possible of intermediate spaces between the blades, or to keep the intermediate spaces as small as possible overall.

In particular, an intermediate space can be reduced in size by the projection or projections. At the same time, the projection or projections can have no effect on the effective contact area and thus the specific impact power and the resulting removal capacity.

A higher number of blades makes it possible to guide the masonry drill in a more stable fashion during a drilling process. The risk that a reinforcement will jam between the blades, which are then formed closer together, can be further reduced.

It may therefore be advantageous in principle to provide a multiplicity of blades on the drill head. However, an increase in the number of blades is also associated with an increase in a contact area between the drill head and the substrate, that is to say, for example, the reinforced masonry. For the same impact energy per impact of the power tool in which this masonry drill is mounted, and for the same impact frequency, the specific impact power in relation to the contact area is thereby reduced. The removal capacity of the masonry drill may therefore decline with the increasing number of blades.

On the basis of previous experience, it has been found that a favorable balance, in particular between the tendency for jamming, stability and removal capacity, is obtained if the drill head has at least three, preferably at most seven, particularly preferably five, blades running outward from a central longitudinal axis of the drill head.

Each of the blades can have at its outer end a projection pointing away from the respective blade tangentially to the longitudinal axis, thus enabling intermediate spaces between adjacent blades to be further reduced in size.

Thus, the masonry drill permits drilling work without any risk, or at most with an extremely small risk, of jamming and hence particularly safe working.

Further features and advantages of the invention are apparent from the following detailed description of exemplary embodiments of the invention, with reference to the figures of the drawings which show details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

### BRIEF DESCRIPTION OF THE DRAWINGS

Exemplary embodiments of the invention are illustrated in the schematic drawings and explained in detail in the following description. In particular, the features described in the dependent claims are also elucidated with reference to the drawing.

In the Figures:

FIG. 1 shows a masonry drill in a side view,

FIG. 2 shows a perspective view of a masonry drill,

FIG. 3 shows another perspective view of the masonry drill,

FIG. 4 shows a plan view of a drill head of the masonry drill,

FIG. 5 shows a perspective view of a front section of the masonry drill and, in particular, of the drill head,

FIGS. 6, 7, 8 and 9 show a number of side views of a partial section of a shaft section and of a drill head, adjoining the latter, of a masonry drill, and

FIG. 10 shows a side view corresponding to the view shown in FIG. 6 of a masonry drill.

### DETAILED DESCRIPTION

In the description of the figures that follows, comprehension of the invention is facilitated by use of the same reference signs in each case for identical or functionally corresponding elements.

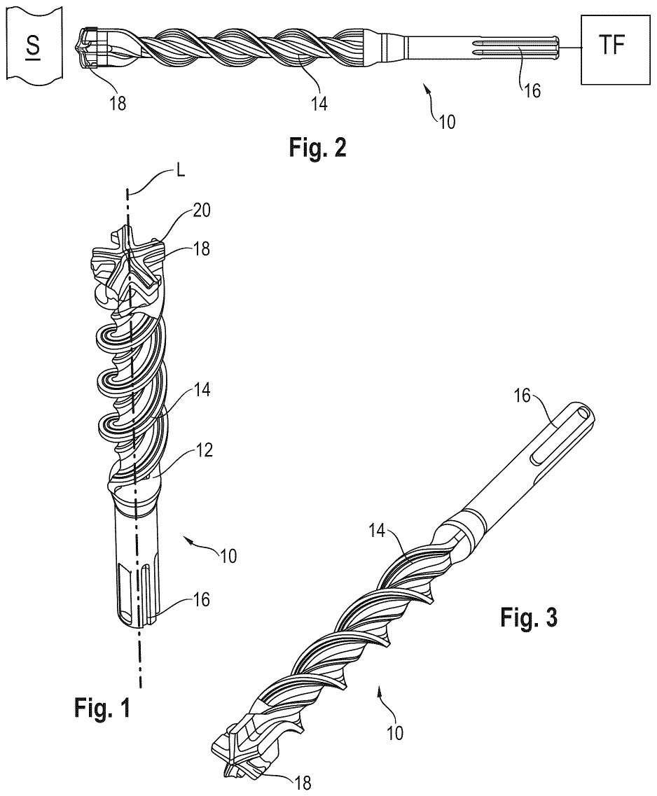

FIG. 1 shows a masonry drill 10 in a side view. The masonry drill 10 comprises a shaft section 12. A conveying helix 14 is formed on the shaft section 12.

A shank section 16 for connection to a tool fitting of a power drill (not shown solely schematically as TF in FIG. 2) is formed at one end of the shaft section 12, and a drill head 18 for work on a substrate (shown solely schematically as S in FIG. 2), e.g. reinforced masonry, is formed at the other end.

The shank section 16 is in the form of a shank generally known as “SDS Max”, for example. It is also conceivable for the shank to be in the form of an “SDS Plus” or similar standardized shank.

The conveying helix 14 is designed as a double-start helix. As an alternative, it would also be conceivable to design the conveying helix as a three-, four-or five-start helix. A double-start helix can transport removed masonry away from the drill head 18 at a high transport rate. It can be of comparatively robust design and can nevertheless be suitable for production at acceptable cost. The flights of the helix are sufficiently far apart to ensure that even relatively large particles of the masonry removed can be conveyed along the conveying helix without jamming. A conveying helix 14 designed as a double-start helix has thus proven to be particularly advantageous.

The drill head 18 has five blades 20. For reasons of clarity, only one blade 20 is indicated by a reference sign.

The blades 20 run outward from a central longitudinal axis L of the drill head 18. It will be understood that the masonry drill 10 can also be operated in an impact mode, in particular along the longitudinal axis L, in order to remove masonry. Overall, it is thus possible to operate the masonry drill 10 in a rotary impact mode to remove masonry.

The masonry drill 10 can be designed for boreholes with a diameter of at least 10 mm and/or at most 32 mm, thus making it possible to ensure a sufficient thickness of material at all points, despite the special geometry described in detail below.

Moreover, with such dimensions, the weight and hence the inertia associated therewith can remain within a range suitable for the removal of masonry by means of rotary impacts.

The drill head 18 preferably comprises a material that is more resistant to breaking than the shank section 12. While the shank section 12 can comprise a steel, for example, the drill head can comprise a hard metal, e.g. a tungsten-based hard metal.

FIG. 2 and FIG. 3 show additional perspective views of the masonry drill 10, making it possible, in particular, to see the conveying helix 14, the shank section 16 and the drill head 18 additionally from further directions of view.

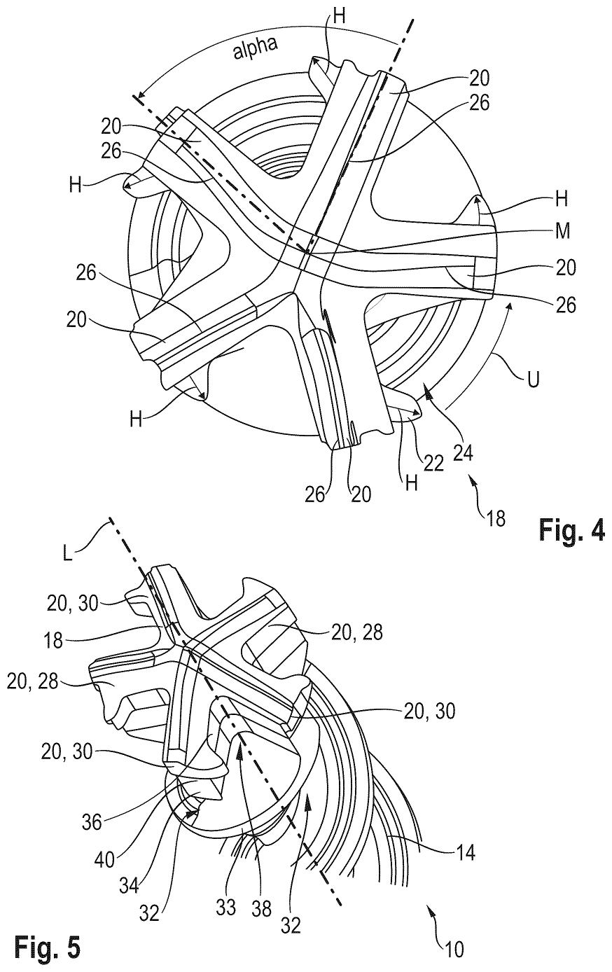

FIG. 4 shows a plan view of the drill head 18. The five blades 20 can be seen.

At its outer ends, each of the blades 20 has a projection 22 pointing away from the respective blade 20 tangentially to the longitudinal axis L. Here too, for reasons of clarity, only one of the projections 22 is indicated by a reference sign.

As can be seen, for example, from FIG. 4, the projections 22 pointing away from the respective blade 20 tangentially to the longitudinal axis L each have at least one main direction H, which has at least one predominant direction component in a tangential direction.

The projections 22 point along a circumferential direction U. The circumferential direction U corresponds to the working direction of rotation of the masonry drill 10, in which it rotates to remove the substrate. Thus, the projections 22 always move somewhat ahead of their associated blades 20 during the removal of masonry.

As an alternative or in addition, it is also conceivable that at least one of the projections 22 points counter to the circumferential direction, that is to say therefore trails its associated blade 20 somewhat in each case.

In particular, it is possible in the case of alternative masonry drills for at least one of the blades 20 to be provided with leading and trailing projections 22.

By means of the projections 22, intermediate spaces 24, of which once again only one is indicated, by way of example, by a reference sign in FIG. 4, between respectively adjacent blades 20 are reduced in size.

At the same time, there remains free space in the intermediate spaces 24, thus enabling comminuted material to get from there to the conveying helix 14.

The blades 20 emanate in a rotationally symmetrical manner, preferably at an angle alpha of between 70° and 80°, in particular 72°, from a central point M of the drill head 18, i.e. transversely to the longitudinal axis L (see FIG. 1). The rotationally symmetrical arrangement results in a particularly uniform distribution of the contact of the drill head 18 with the substrate across the cross section of the drill head 18. As a result, the masonry drill 10 can be introduced in a very stable manner into the substrate to be drilled.

The blades 20 have cutting edges 26. With the exception of one cutting edge 26, that is to say, in FIG. 4, apart from the cutting edge 26 at about 1 o'clock, i.e. which runs obliquely upward to the right, the cutting edges 26 are curved.

It is also conceivable to form an alternative masonry drill 10 with such cutting edges 26 but without projections 22. Such an alternative masonry drill 10 can have one or more of the features described above and/or below and/or features contained in the drawing, in particular with the exception of the features which relate to the projections 22.

FIG. 5 shows another perspective view of the masonry drill 10. In particular, the end of the masonry drill 10 with its drill head 18 can be seen.

Two of the five blades 20, in particular the free ends thereof, are set back rearward, i.e. parallel to the longitudinal axis L in the direction of the conveying helix 14, relative to the respective blades 20 that are adjacent to them. They form secondary blades 28. Thus, the drill head 18 strikes the substrate to be drilled primarily with the three remaining blades 20, referred to below as main blades 30.

The secondary blades 28 have a greater curvature perpendicularly to the longitudinal axis L than the main blades 30, thus further improving the removal of drilling dust.

This results in the masonry drill 10 with its five blades 20 having a particularly high specific impact power and, as a result, a particularly high removal capacity.

Apart from their stabilizing function, which has already been described above, the secondary blades 28 can be used particularly when the masonry drill 10 strikes a reinforcement, e.g. a steel reinforcement, and possibly enters a certain distance into the latter. The secondary blades 28 can then accelerate the removal of the reinforcement.

It can furthermore be seen from FIG. 5 that the free ends of the projections 22 are set back rearward relative to their blade-facing ends, i.e. toward the conveying helix 14, and therefore, during normal removal of masonry, the projections 22 likewise do not strike the substrate, thereby additionally minimizing the effective contact area in favor of a high specific impact power. Together with the side faces of the blades 20, the projections 22 also form sliding surfaces, along which comminuted material can be guided to the conveying helix 14, and therefore the offsetting of the free ends of the projections 22 toward the rear also improves removal of the comminuted material.

It can furthermore be seen from FIG. 5, and also in conjunction with FIG. 1 to FIG. 3, that the conveying helix 14 is of double-start design in order to achieve a high conveying capacity.

Blades 20 which do not directly adjoin a helix wall 33, of which once again, for reasons of clarity, only one helix wall 33 is indicated by a reference sign in FIG. 5, of one of the helix grooves 32 of the conveying helix 14 are supported by support bodies 34 projecting from the conveying helix 14. The support bodies 34 are formed independently of the helix walls 33 in such a way as to project from the conveying helix 14. One such support body 34 is therefore formed for the five blades 20 and the double-start conveying helix 14.

The support bodies 34 thus make it possible to connect a drill head 18 to a number of blades 20 by means of a conveying helix 14 which has a different number of helix walls 33 from the number of blades 20. In particular, a drill head 18 can be provided together with an uneven number of blades 20 with a conveying helix 14 having an even number of grooves. Thus, particularly advantageous configurations of the respective drill head 18 can be combined with particularly advantageous configurations of the conveying helix 14.

All the blades 20 open into the conveying helix 14 along walls 36, of which once again, for reasons of clarity, only one wall 36 is provided with a reference sign in FIG. 5. The walls 36 run parallel to the longitudinal direction L, and therefore introduction regions 38, of which once again only one is provided with a reference sign, which open into the conveying helix 14 are obtained parallel to the longitudinal direction L. The introduction regions 38 and, in particular, the walls 36 running parallel to the longitudinal direction L, serve for further improved removal of comminuted material.

The drill head 18 can preferably be butt-jointed to the shaft section 12 by means of a metallurgical joining zone 40 in order to ensure the necessary strength of the connection. The metallurgical joining zone 40 can be produced by means of welding or brazing, for example.

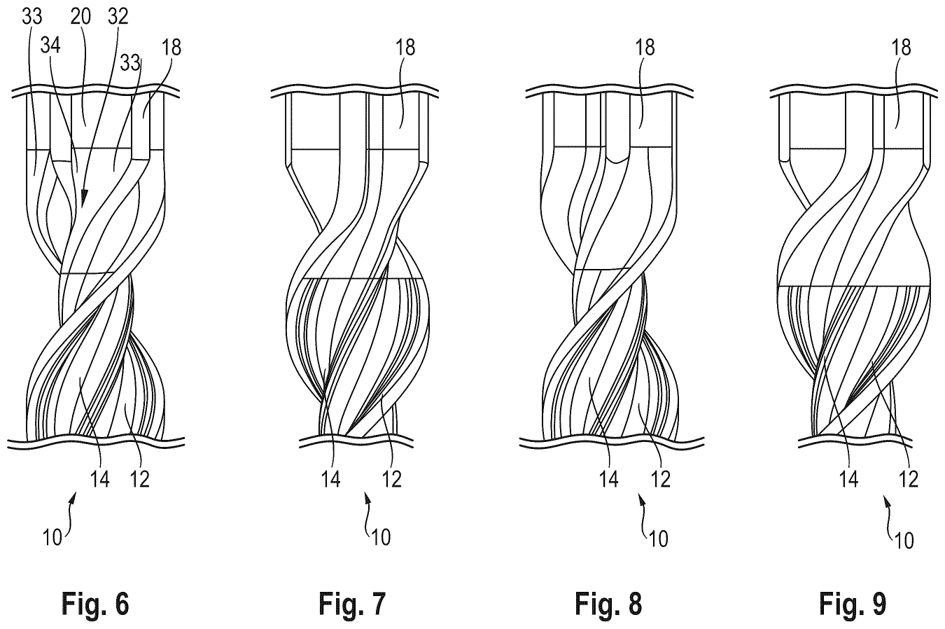

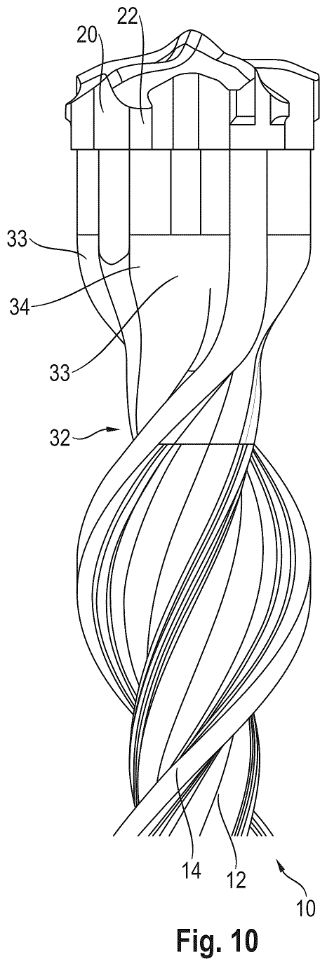

FIGS. 6 to 9 show a number of side views, from different angles of view, of a partial section of a shaft section 12 and of a drill head 18, adjoining the latter, of a masonry drill 10.

It can be seen especially from FIG. 6 that the blade 20 provided with a reference sign is seated on the support body 34. The support body 34 in turn is designed so as to project from the conveying helix 14. It is located between two helix walls 33 of one of the helix grooves 32.

Such support of blades 20 by support bodies 34 can be provided both for blades 20 with a tangential projection and for blades 20 without a tangential projection. By way of example, blades 20 without a tangential projection are illustrated in FIG. 6 to FIG. 9.

In a view corresponding to FIG. 6, FIG. 10 shows a partial section of a masonry drill 10 on which blades 20 have a tangential projection 22, wherein once again only one blade 20 and the associated projection 22 are indicated by reference signs.

### LIST OF REFERENCE SIGNS

10 Masonry drill
12 Shaft section
14 Conveying helix
16 Shank section
18 Drill head
20 Blade
22 Projection
24 Intermediate space
26 Cutting edge
28 Secondary blade
30 Main blade
32 Helix groove
33 Helix wall
34 Support body
36 Wall
38 Introduction region
40 Metallurgical joining zone
H Main direction
L Longitudinal axis
M Central point
U Circumferential direction
Alpha Angle

What is claimed is:

1-12. (canceled)

13. A masonry drill comprising:
a shaft section having a first end and a second end;
a shank section for connection to a tool fitting of a power drill formed at the first end, and
a drill head for work on a substrate formed at the second end, the drill head having at least one blade running outward from a central longitudinal axis of the drill head, the blade having at an outer end a projection pointing away from the blade tangentially to the longitudinal axis.

14. The masonry drill as recited in claim 13 wherein the at least one blade includes at least three blades.

15. The masonry drill as recited in claim 13 wherein the at least one blade has between three and seven blades.

16. The masonry drill as recited in claim 15 wherein the at least one blade numbers exactly five blades.

17. The masonry drill as recited in claim 14 wherein each of the three blades has at its outer end a respective projection.

18. The masonry drill as recited in claim 13 wherein the projection points along a circumferential direction corresponding to a working direction of rotation of the masonry drill.

19. The masonry drill as recited in claim 13 wherein a plurality of blades of the at least one blade emanate in a rotationally symmetrical manner from a central point (M) of the drill head.

20. The masonry drill as recited in claim 13 wherein one of the at least one blade is set back rearwardly parallel to the longitudinal axis in the direction of the shaft section relative to an adjacent blade of the at least one blade.

21. The masonry drill as recited in claim 13 wherein a free end of the projection is set back rearwardly relative to a blade-facing end of the projection.

22. The masonry drill as recited in claim 13 further comprising a double-start conveying helix formed on the shaft section.

23. The masonry drill as recited in claim 22 wherein the at least one blade is supported by a support body projecting from the conveying helix.

24. The masonry drill as recited in claim 13 further comprising a metallurgical joining zone between the drill head and the shaft section.

25. The masonry drill as recited in claim 13 wherein the drill head has a diameter of at most 32 mm.

26. The masonry drill as recited in claim 13 wherein the drill head has a diameter of at least 10 mm.
